(19) United States
(12) Patent Application Publication
(10) Pub. No.: US 2022/0181645 A1
(43) Pub. Date: Jun. 9, 2022

(54) CATALYST, ELECTRODE, AND METHOD OF PREPARING THE SAME FOR PEM FUEL CELLS

(71) Applicant: HYZON MOTORS INC., Honeoye Falls, NY (US)

(72) Inventor: Rajesh Bashyam, Delta (CA)

(21) Appl. No.: 17/546,181

(22) Filed: Dec. 9, 2021

Related U.S. Application Data
(60) Provisional application No. 63/123,001, filed on Dec. 9, 2020.

(51) Int. Cl. H01M 4/92; H01M 4/88; H01M 8/1004; H01M 4/86

(52) U.S. Cl. CPC H01M 4/926; H01M 4/8828; H01M 2008/1095; H01M 4/921; H01M 4/8663; H01M 8/1004

(57) ABSTRACT

Catalysts that include a carbon support and a metal, as well as methods of making such catalysts, electrodes including such catalysts, and fuel cells employing such electrodes are provided. The carbon support includes a high surface area porous carbon, a low surface area graphitized carbon, and a low surface area nonporous carbon. The metal includes platinum and/or one or more platinum alloys, where the metal is deposited onto the carbon support. The catalyst can be used in a catalyst ink and can form an electrode along with an ionomer for use in a fuel cell.

### CROSS-REFERENCE TO RELATED APPLICATIONS

This application claims the benefit of U.S. Provisional Application No. 63/123,001, filed on Dec. 9, 2020. The entire disclosure of the above application is hereby incorporated herein by reference.

### FIELD

The present technology relates to fuel cell catalysts, and more particularly, to a method of manufacturing fuel cell catalysts.

### INTRODUCTION

This section provides background information related to the present disclosure which is not necessarily prior art.

Fuel cell systems can be used as power supplies in numerous applications, such as vehicles and stationary power plants. Such systems can deliver power economically and with environmental and other benefits. To be commercially viable, however, fuel cell systems should exhibit adequate reliability in operation, even when the fuel cells are subjected to conditions outside their preferred operating ranges.

Fuel cells convert reactants, namely, fuel and oxidant, to generate electric power and reaction products. Proton-exchange membrane fuel cells (PEM fuel cells), also referred to as polymer-electrolyte membrane fuel cells, can employ a membrane electrode assembly (MEA) comprised of a proton exchange membrane (e.g., proton conducting ionomer) disposed between two electrodes, namely a cathode and an anode. A catalyst typically facilitates the desired electrochemical reactions at the electrodes. Separator plates or bipolar plates, including plates providing a flow field for directing the reactants across a surface of each electrode, and/or various types of gas-diffusion media, can be disposed on each side of the MEA.

In operation, the output voltage of an individual fuel cell under load can be below one volt. Therefore, in order to provide greater output voltage, multiple fuel cells can be stacked together and can be connected in series to create a higher voltage fuel cell stack. End plate assemblies can be placed at each end of the stack to hold the stack together and to compress the stack components together. Compressive force can provide sealing and adequate electrical contact between various stack components. Fuel cell stacks can then be further connected in series and/or parallel combinations with other fuel cell stacks or power sources to form larger arrays for delivering higher voltages and/or currents.

The catalyst used in the electrodes of the MEA can include one or more various metals, including noble metals, embedded and/or supported on various types of media, including proton conducting media. A carbon-supported catalyst can be used in fuel cell electrodes at both the anode and the cathode for the respective hydrogen oxidation and oxygen reduction reactions. Such catalysts can include platinum (Pt) and Pt-alloys, such as platinum-cobalt (Pt—Co), platinum-nickel (Pt—Ni), platinum-iron (Pt—Fe), and/or platinum-manganese (Pt—Mn) supported on high surface area or low surface area carbon media.

There can be a trade-off associated with performance and durability of the electrode when the catalyst is either supported on high surface area or low surface area carbon. When the catalyst is supported on high surface area carbon, the durability can be compromised due to Pt agglomeration, dissolution, and carbon oxidation, where it is also possible that utilization of the precious metal can be compromised. When the catalyst is supported on low surface area carbon, the electrochemical surface area of Pt and hence performance thereof can be compromised.

Accordingly, there is a continuing need for optimizing the carbon support for the catalyst to obtain desired performance and durability requirements for PEM fuel cells.

### SUMMARY

In concordance with the instant disclosure, optimized catalysts, catalyst inks, electrodes, fuel cells including such electrodes, and methods of making such catalysts have been surprisingly discovered.

The present technology includes articles of manufacture, systems, and processes that relate to a catalyst including a carbon support and a metal. The carbon support can include a high surface area porous carbon, a low surface area graphitized carbon, and a low surface area nonporous carbon. The metal can include one or more of platinum and various platinum alloys, where the metal can be deposited onto the carbon support. Electrodes formed using the catalyst can include an ionomer, such as perfluorosulfonic acid. Membrane electrode assemblies and fuel cells employing such electrodes can have anodes and/or cathodes formed from such catalysts.

Methods of making catalysts are provided where a high surface area porous carbon, a low surface area graphitized carbon, and a low surface area nonporous carbon are blended to form a blended carbon support. A catalyst precursor including a platinum containing precursor and/or one or more various platinum alloy containing precursors can be deposited onto the carbon blend to form a post-deposition carbon blend. The post-deposition carbon blend can be heated to form a carbon supported catalyst including a metal deposition product. It is further possible to chemically treat the carbon blend with one of an oxidizing agent and an acidic condition prior to depositing the catalyst precursor onto the carbon blend to form the post-deposition carbon blend. It is also possible to heat the carbon blend in one of an inert atmosphere and air prior to depositing the metal precursor onto the carbon blend to form the post-deposition carbon blend. Furthermore, the post-deposition carbon blend can be collected, washed, and dried one or more times prior to the heating to form the carbon supported catalyst including the metal deposition product.

Further areas of applicability will become apparent from the description provided herein. The description and specific examples in this summary are intended for purposes of illustration only and are not intended to limit the scope of the present disclosure.

### DRAWINGS

The drawing described herein is for illustrative purposes only of selected embodiments and not all possible implementations, and are not intended to limit the scope of the present disclosure.

FIG. 1 is a flowchart representing an embodiment of a method of preparing a catalyst according to the present technology;

FIG. 2 is a flowchart representing an embodiment of carbon blending according to the present technology;

FIG. 3 is a flowchart representing an embodiment of depositing a catalyst precursor on a carbon blend according to the present technology;

FIG. 4 is a flowchart representing an embodiment of washing a post-deposition carbon blend according to the present technology; and

FIG. 5 is a flowchart representing an embodiment of a method of making an electrode according to the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology provides various ways of making catalysts, where such catalysts can be used in electrodes incorporated into membrane electrode assemblies as well as proton exchange membrane fuel cells, which can be used as power plants in various applications, including vehicular applications. A catalyst for a fuel cell can include a carbon support and a metal. The carbon support can include one or more of a high surface area porous carbon, a low surface area graphitized carbon, and a low surface area nonporous carbon. In certain embodiments, the carbon support includes the high surface area porous carbon, the low surface area graphitized carbon, and the low surface area nonporous carbon. The metal can include platinum and/or a platinum alloy. The metal can be deposited onto the carbon support.

The catalyst for a fuel cell can further include various aspects. The carbon support can be formed from a carbon blend of the high surface area porous carbon, the low surface area graphitized carbon, and/or the low surface area nonporous carbon. The high surface area porous carbon can have a surface area from about 300 m²/g to about 1200 m²/g. The low surface area graphitized carbon can have a surface area from about 125 m²/g to about 300 m²/g. And the low surface area nonporous carbon can have a surface area from about 50 m²/g to about 125 m²/g. The metal can include platinum and/or one or more platinum alloys. Examples of platinum alloys include platinum-cobalt (Pt—Co), platinum-nickel (Pt—Ni), platinum-iron (Pt—Fe), and platinum-manganese (Pt—Mn). The catalyst and a liquid vehicle can be combined to form a slurry or ink that can be used to form an electrode for use in a membrane electrode assembly of a proton exchange membrane fuel cell.

In certain embodiments, the present technology provides ways of making and using an electrode for a fuel cell. The electrode can include a carbon support, a metal, and an ionomer. As described, the carbon support can include a high surface area porous carbon, a low surface area graphitized carbon, and/or a low surface area nonporous carbon. The metal can include platinum and/or one or more platinum alloys, where the metal is deposited onto the carbon support. The ionomer can include various ionomers used in fuel cell electrodes, such as perfluorosulfonic acid. Such electrodes can be used in making membrane electrode assemblies in conjunction with a proton exchange membrane; e.g., a sulfonated tetrafluoroethylene based fluoropolymer-copolymer.

Methods of making catalysts are also provided by the present technology. Such methods can include blending a high surface area porous carbon, a low surface area graphitized carbon, and a low surface area nonporous carbon to form a carbon blend. A catalyst precursor can be deposited onto the carbon blend to form a post-deposition carbon blend, where the catalyst precursor includes a platinum precursor and/or one or more platinum alloy precursors. The post-deposition carbon blend can be heated to form a carbon supported catalyst, where the carbon supported catalyst includes a metal deposition product of platinum and/or one or more of the platinum alloy precursors.

Various additional aspects can be applied to methods of making such catalysts. With respect to the blending of the carbon species, a particle size of the carbon blend can be ascertained following the blending operation and the blending step can be repeated until a predetermined particle size is obtained for the carbon blend. For example, various types of mixing, grinding, and milling operations can be performed to form a substantially homogenous carbon blend of particles including the high surface area porous carbon, the low surface area graphitized carbon, and the low surface area nonporous carbon. It is further possible to chemically treat the carbon blend with one of an oxidizing agent and an acidic condition prior to the depositing step. Likewise, it is further possible to heat treat the carbon blend in one of an inert atmosphere and air prior to the depositing step. Such treatments of the carbon blend can serve to functionalize the carbon blend particles and thereby improve the deposition of the catalyst precursor thereon. Such treatments of the carbon blend can also serve to alter the shape and/or alter the relative porosities of the carbon particles.

Various washing operations can be incorporated in methods of making catalysts. For example, the post-deposition carbon blend can be washed prior to the heating step. The washing can remove undeposited catalyst precursor and any solvent or liquid vehicles used in mixing the catalyst precursor and carbon blend, as well as remove any solvent or liquid vehicles used in the blending operation used to form the carbon blend. The washing of the post-deposition carbon blend can be repeated a predetermined number of times or until an amount of residual undeposited catalyst precursor drops below a predetermined threshold. Washing the post-deposition carbon blend can be followed by drying the post-deposition carbon blend prior to the heating step. In certain embodiments, the drying can be combined with the heating step.

Method of making electrodes including the catalysts provided herein are also contemplated by the present technology. Such methods can include making a catalyst in one of the ways described herein. The carbon supported catalyst, a solvent, and an ionomer can then be mixed to form a slurry or ink. The slurry or ink can be deposited onto a surface. The solvent can then be removed to form the electrode. In this way, an electrode can be formed by spray coating, calendaring, or casting the slurry or ink, as well through the use of other ways available in the art of forming films or layers on various surfaces or substrates. The slurry or ink can be deposited onto various surfaces, including a proton exchange membrane and/or a gas diffusion layer. Certain methods can include transferring the electrode from the surface to another surface, such as a proton exchange membrane. Transfer can be effected by a pressing operation, roll to roll transfer, as well as other ways available in the art. Removal of the solvent to form the electrode can include volatilizing the solvent. A solid or semisolid electrode can remain on the surface after removal of the solvent, which can include the use of heat and/or vacuum.

As set forth herein, the present technology provides optimized carbon supported catalysts for use in fuel cell electrodes, including the anode and/or the cathode for hydrogen oxidation and oxygen reduction reactions, respectively. The catalysts can include Pt or Pt-alloys such as Pt—Co, Pt—Ni, Pt—Fe, Pt—Mn supported on a particular blend of carbon materials including a high surface area porous carbon, a low surface area graphitized carbon, and a low surface area nonporous carbon. As there can be a trade-off associated with performance and durability when the catalyst is either supported solely on high surface area or low surface area carbon, the present technology can overcome such issues. For example, when a catalyst is supported solely on high surface area carbon, the durability can be compromised due to Pt agglomeration and dissolution and carbon oxidation, and also sometimes the utilization of the precious metal can be compromised. What is more, when the catalyst is supported solely on low surface area graphitized carbon, the electrochemical surface area of Pt and hence the catalyst performance thereof can be compromised. The blend of carbon materials provided herein can surprisingly address these issues and maximize performance of the catalyst in an MEA of a fuel cell. In particular, the present carbon support is designed with optimized physiochemical properties by blending carbon materials, including porous and non-porous carbon supports and high surface area and low surface area graphitized carbon in certain ratios, which can be followed by chemical and thermal treatments before catalyst deposition with minimal trade-off in performance and durability.

In certain embodiments, preparation of a catalyst according to the present technology can include the following aspects. A high surface area porous carbon, a low surface area graphitized carbon, and a low surface area nonporous carbon can be blended to form a blended carbon support. Optionally, the blended carbon support can be chemically treated with one of an oxidizing agent and an acidic condition. The blended carbon support can optionally also be heat treated an inert atmosphere or in air after it is formed or after the chemical treatment with the oxidizing agent or acidic condition. A metal precursor, including a platinum precursor and/or one or more platinum alloy precursors, can be deposited onto the blended carbon support to form a precursor deposition product. Optionally, the precursor deposition product can be collected (e.g., by filtration), washed, and dried one or more times. Collection, washing, and drying can remove any residual oxidizing agent or acidic condition provided when the blended carbon support is chemically treated, for example. The precursor deposition product can then be heated to form a metal deposition product. Thermal energy with or without an inert gas, such as nitrogen or argon, for example, can be used to decompose the organic metal precursor(s) to leave the metal deposited on the blended carbon support.

Catalysts prepared in this manner can be used to make various catalyst slurries or inks using a three-step mixing process, such as a low shear, medium shear, and high shear mechanical process. An example of low shear conditions includes overhead mechanical mixing with a rotation speed between about 300 and about 1,000 RPM. An example of medium shear conditions includes overhead mechanical mixing with rotation speed between about 1,000 and about 5,000 RPM. An example of high shear conditions includes high pressure mechanical blending at about 2,000 to about 20,000 psi. The catalyst slurry or ink can be coated on a fluorinated substrate or directly coated on an ionomer (e.g., perfluorosulfonic acid (PFSA) membrane) to form a catalyst coated membrane (CCM) and MEAs, which can be assembled along with appropriate gas diffusion media and evaluated for performance and durability through Accelerated Stress Test protocols for Pt dissolution.

With respect to the carbon support used in the present technology, the carbon support can include a blend of a high surface area porous carbon, a low surface area graphitized carbon, and a low surface area nonporous carbon. In certain embodiments, the high surface area porous carbon can have a surface area from about 300 m²/g to about 1,200 m²/g. The high surface area porous carbon can also have a surface area between 300 m²/g and 1,200 m²/g. In certain embodiments, the low surface area graphitized carbon can have a surface area from about 125 m²/g to about 300 m²/g. The low surface area graphitized carbon can also have a surface area between 125 m²/g and 300 m²/g. And in certain embodiments, the low surface area nonporous carbon can have a surface area from about 50 m²/g to about 125 m²/g. The low surface area nonporous carbon can also have a surface area between 50 m²/g and 125 m²/g.

### EXAMPLES

Example embodiments of the present technology are provided with reference to the several figures enclosed herewith.

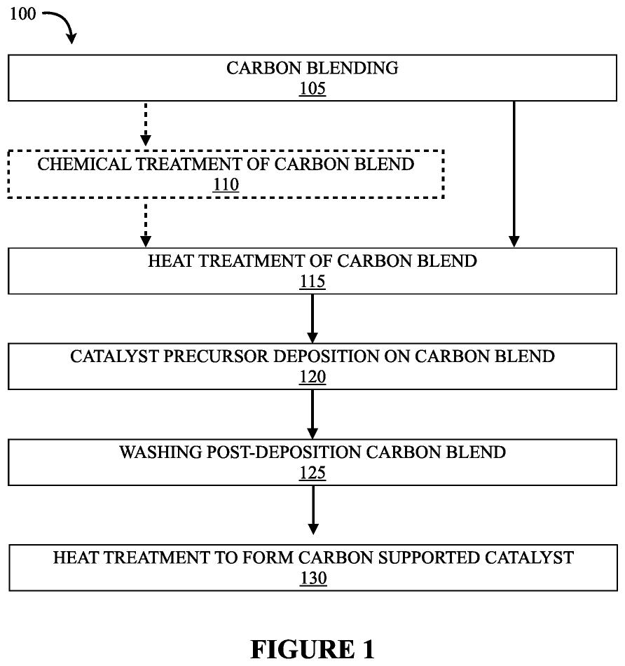

With reference to FIG. 1, an embodiment of a method of making a catalyst is shown at 100. A carbon blending step 105 includes blending various carbon species having various morphologies. For example, high surface area carbon particles can provide high catalyst performance by increasing the active area of catalyst deposited thereon. However, high surface area carbon particles can be less durable and more susceptible to physical, thermal, and/or chemical stresses. Low surface area carbon particles, conversely, can be more durable and resistant to physical, thermal, and/or chemical stresses, but have a decreased active area of catalyst deposited thereon. A balance can therefore be obtained in forming the present carbon blend, where a compromise of catalyst performance and durability can be achieved in optimizing the nature of the carbon support for the metal catalyst.

An optional chemical treatment of the carbon blend is shown at 110, where the carbon blend can be exposed to an oxidizing agent and/or an acidic condition. In this way, the chemical treatment can functionalize the carbon blend by forming oxidation products on the carbon particles. Such oxidation products can include various oxygen-containing pendant functional groups on the surface and/or within the pores of the carbon species of the carbon blend. These oxygen-containing pendant functional groups can improve various interactions, including ionic coordination and/or covalent bonding with metal catalysts.

The carbon blend is heat treated, as shown at 115. Heat treatment can be effected in an inert atmosphere (e.g., nitrogen and/or a noble gas, such as argon) or in air. Heat treatment at 115 can remove any volatiles left from the carbon blending at 105 and/or the chemical treatment at 110. Heat treatment of the carbon blend can serve to functionalize the carbon blend particles and thereby improve the deposition of the catalyst precursor thereon. Heat treatment of the carbon blend can also serve to alter the shape and/or alter the relative porosities of the carbon particles in the carbon blend.

Shown at 120, a catalyst precursor is deposited on the carbon blend. The deposition operation forms a post-deposition carbon blend, where the catalyst precursor can interact with the various carbon species based upon the respective surface areas, porosity, and proportion thereof in the carbon blend. The catalyst precursor can include a platinum precursor and/or one or platinum alloy precursors. Examples of platinum precursors include platinum acetylacetonates, platinum nitrate, hexachloroplatinic acid, trimethyl (methyl cyclopentadienyl) platinum, and various metalorganic compounds and surfactants. Examples of platinum alloy precursors include similar compounds having platinum alloys. The catalyst precursor can be heat labile such that subsequent heating and exposure to various sources of thermal energy can result in at least a partial decomposition of the catalyst precursor. In certain embodiments, the catalyst precursor can be heat labile to where an organic portion of the precursor effectively decomposes, breaks down, and/or volatilizes, leaving a metal or metal alloy at the deposition site.

The post-deposition carbon blend is washed, as shown at 125. The washing removes undeposited catalyst precursor from the post-deposition carbon blend. Likewise, any solvents and/or liquid vehicles used in the carbon blending step at 105 and any oxidizing agents or acidic components used in the chemical treatment step at 110 can be removed, if not already volatilized and/or decomposed by the heat treatment of the carbon blend at 115. Washing can be effected using various separation processes to form a solid phase including the post-deposition carbon blend and a liquid phase including any of the aforementioned residuals as well as any washing solvent employed in step 125.

Shown at 130, heat treatment is applied to form a carbon supported catalyst. The deposited catalyst precursor, being heat labile, decomposes to leave a metal deposition product. It is possible for the various carbon species to interact with the metal, including where prior chemical treatment at 110, prior heat treatment at 115, and/or the present heat treatment at 130 has provided or does provide certain functional groups, including various oxygen-containing pendant functional groups, that can interact and/or react with the metal following decomposition of the catalyst precursor. In this way, the carbon supported catalyst includes a metal deposition product stably bound or coordinated with the carbon support.

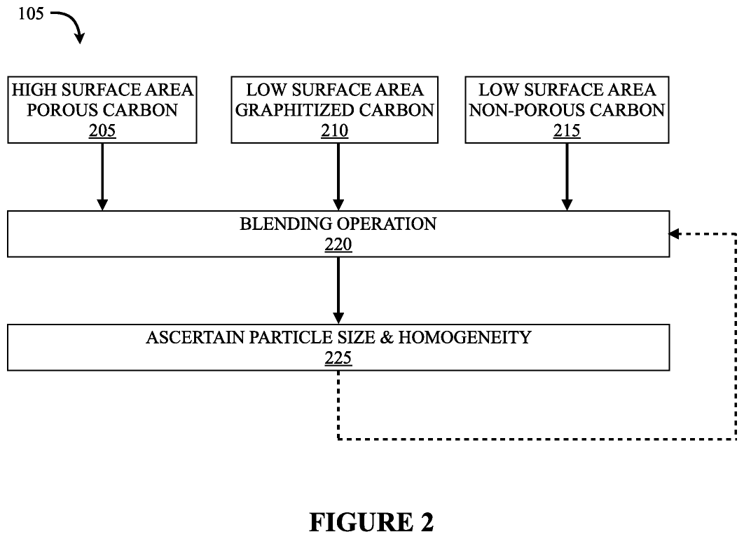

Turning now to FIG. 2, an embodiment of the carbon blending step 105 is shown. The carbon blending 105 includes inputs of high surface area porous carbon 205, low surface area graphitized carbon 210, and low surface area nonporous carbon 215. Examples of high surface area porous carbon include Black pearl. Examples of low surface area semi graphitized carbon include Vulcan XC72. Examples of low surface area nonporous carbon include Cabot. Each of these carbon species can be provided as particles of one or more preselected sizes. The carbon species are subjected to a blending operation 220 that can range from general mixing to provide a substantially homogenous mixture, to operations including mixing, grinding, and/or milling operations can be performed to form a substantially homogenous carbon blend of particles of a predetermined size. For example, by subjecting a combination of the high surface area porous carbon, the low surface area graphitized carbon, and the low surface area nonporous carbon to a blending operation 220, it is possible to mix and grind/mill the carbon blend to a relatively uniform particle size and homogeneity. At one or more points in the blending operation 220, the carbon blend can be tested, as shown at 225, to ascertain particle size and homogeneity of the blend. The blending operation at 220 can be continued until desired physical characteristics are achieved.

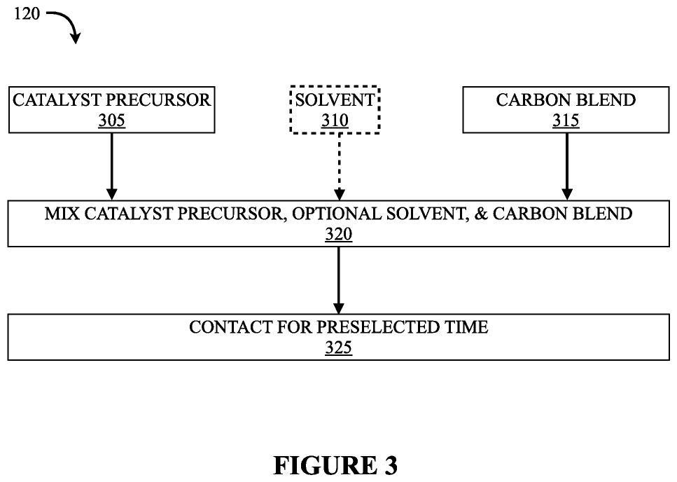

Turning now to FIG. 3, an embodiment of the catalyst precursor deposition on the carbon blend is shown at 120. The catalyst precursor 305, optional solvent 310, and the carbon blend 315 are mixed at 320 to effectively contact the surface area of the respective carbon species with the catalyst precursor. The mixture can be allowed to contact for a preselected time, as shown at 325, in order to allow the catalyst precursor 305 to permeate the available surface area and any pores of the respective carbon species. Smaller particle sizes of the carbon blend 315 may require shorter contact times, whereas larger particle sizes of the carbon blend 315 may require longer contact times to thoroughly wet the particles. The contact in step 325 can be assisted by various applications of agitation, mixing, and/or vacuum to the catalyst precursor 305, optional solvent 310, and the carbon blend 315.

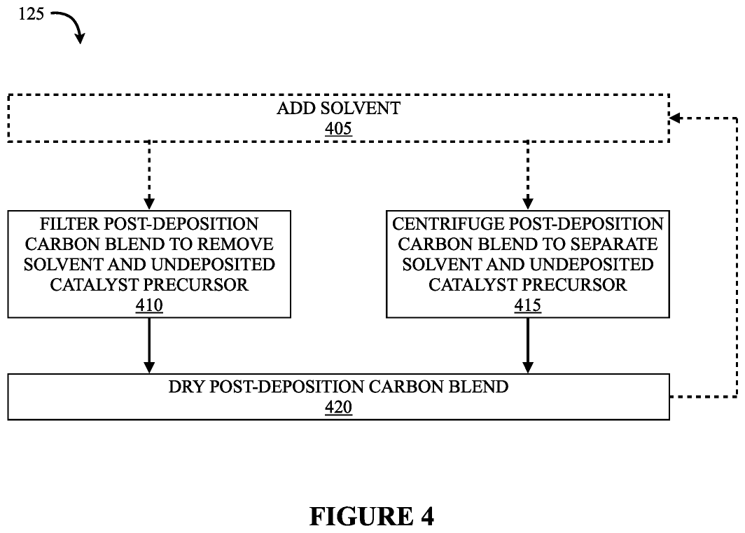

Turning now to FIG. 4, an embodiment of washing the post-deposition carbon blend 125 is shown. Washing can include the optional addition of a solvent 405 or liquid vehicle to the post-deposition carbon blend. The solvent 405 can dilute any undeposited catalyst precursor and can suspend the post-deposition carbon blend therein to more thoroughly remove undeposited catalyst precursor. The post-deposition carbon blend is separated from the solvent and/or undeposited catalyst precursor by various means, such as filtering the post-deposition carbon blend, as shown at 410, or by density separation methods, such as centrifugation as shown at 415. Washing of the post-deposition carbon blend 125 can include drying the post-deposition carbon blend, as shown at 420. Drying can be effected by heat and/or atmosphere circulation, including the use of spray drying and fluidized bed processes.

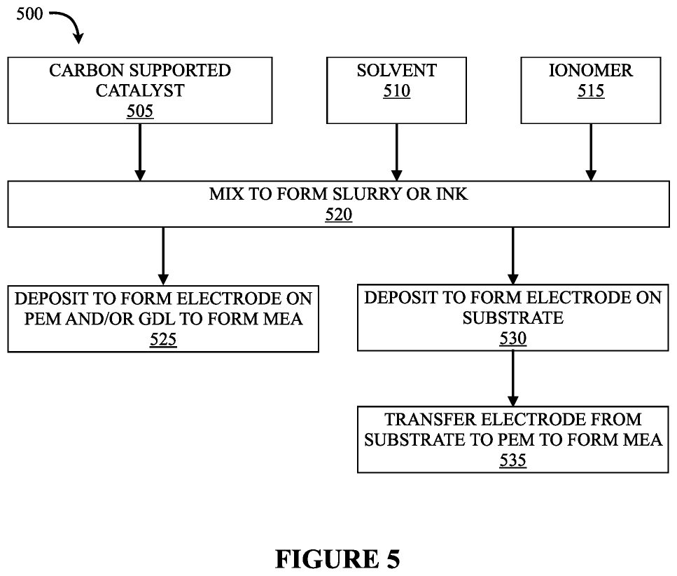

Turning now to FIG. 5, an embodiment of forming an electrode using the carbon supported catalyst is shown at 500. The carbon supported catalyst supplied at 505 can include the output of the method of FIG. 1, identified by the carbon supported catalyst at 130 therein. The carbon supported catalyst 505, solvent 510, and ionomer 515 are mixed to form a slurry or ink, as shown at 520. The slurry or ink is then deposited on a surface to form an electrode, where the slurry or ink can be directly deposited on a proton exchange membrane (PEM) and/or gas diffusion layer (GDL) to form an electrode thereon, as shown at 525, or where the slurry or ink is deposited onto a substrate to form an electrode thereon, as shown at 530, the electrode subsequently being transferred from the substrate to a PEM, as shown at 535, to form a membrane electrode assembly (MEA).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A catalyst for a fuel cell, comprising:
a carbon support including a high surface area porous carbon, a low surface area graphitized carbon, and a low surface area nonporous carbon; and
a metal selected from a group consisting of platinum, a platinum alloy, and combinations thereof, wherein the metal is deposited onto the carbon support.

2. The catalyst of claim 1, wherein the high surface area porous carbon has a surface area from about 300 m²/g to about 1200 m²/g.

3. The catalyst of claim 1, wherein the low surface area graphitized carbon has a surface area from about 125 m²/g to about 300 m²/g.

4. The catalyst of claim 1, wherein the low surface area nonporous carbon has a surface area from about 50 m²/g to about 125 m²/g.

5. The catalyst of claim 1, wherein the platinum alloy includes a member selected from a group consisting of: platinum-cobalt (Pt—Co), platinum-nickel (Pt—Ni), platinum-iron (Pt—Fe), platinum-manganese (Pt—Mn), and combinations thereof.

6. A catalyst slurry or ink comprising the catalyst of claim 1 and a liquid vehicle.

7. An electrode for a fuel cell, comprising:
a carbon support including a high surface area porous carbon, a low surface area graphitized carbon, and a low surface area nonporous carbon;
a metal selected from a group consisting of platinum, a platinum alloy, and combinations thereof, wherein the metal is deposited onto the carbon support; and
an ionomer.

8. The electrode of claim 7, wherein the ionomer includes perfluorosulfonic acid.

9. A membrane electrode assembly comprising the electrode according to claim 7 and a proton exchange membrane.

10. A method of making a catalyst, comprising:
blending a high surface area porous carbon, a low surface area graphitized carbon, and a low surface area nonporous carbon to form a carbon blend;
depositing a catalyst precursor onto the carbon blend to form a post-deposition carbon blend, wherein the catalyst precursor is selected from a group consisting of a platinum precursor, a platinum alloy precursor, and combinations thereof; and
heating the post-deposition carbon blend to form a carbon supported catalyst, wherein the carbon supported catalyst includes a metal deposition product selected from a group consisting of platinum, platinum alloy, and combinations thereof.

11. The method of claim 10, further comprising ascertaining a particle size of the carbon blend following the blending step and repeating the blending step until a predetermined particle size is obtained for the carbon blend.

12. The method of claim 10, further comprising chemically treating the carbon blend with one of an oxidizing agent and an acidic condition prior to the depositing step.

13. The method of claim 10, further comprising heat treating the carbon blend in one of an inert atmosphere and air prior to the depositing step.

14. The method of claim 10, further comprising washing the post-deposition carbon blend prior to the heating step.

15. The method of claim 14, further comprising repeating the washing of the post-deposition carbon blend prior to the heating step.

16. The method of claim 14, wherein washing the post-deposition carbon blend is followed by drying the post-deposition carbon blend prior to the heating step.

17. A method of making an electrode, comprising:
making the catalyst according to the method of claim 10;
mixing the catalyst, a solvent, and an ionomer to form a slurry or ink;
depositing the slurry or ink onto a surface; and
removing the solvent to form the electrode.

18. The method of claim 17, wherein the surface includes a member selected from a group consisting of a proton exchange membrane, a gas diffusion layer, and combinations thereof.

19. The method of claim 17, further comprising transferring the electrode from the surface to a proton exchange membrane.

20. The method of claim 17, wherein removing the solvent includes volatilizing the solvent.
